(19) United States
(12) Patent Application Publication
(10) Pub. No.: US 2025/0086930 A1
(43) Pub. Date: Mar. 13, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Nagamasa MISU, Kanagawa (JP); Masahiko MIZUMURA, Kanagawa (JP); Seiji SHIRAKI, Kanagawa (JP); Yushiro TANAKA, Kanagawa (JP); Saki SHIDARA, Kanagawa (JP)

(73) Assignee: FUJIFILM Business Innovation Corp., Tokyo (JP)

(21) Appl. No.: 18/586,564

(22) Filed: Feb. 26, 2024

(30) Foreign Application Priority Data
Sep. 11, 2023 (JP) 2023-146656

(51) Int. Cl. G06V 10/56

(52) U.S. Cl. CPC G06V 10/56

(57) ABSTRACT

An information processing system includes a processor configured to correct a pixel of interest that is a colored pixel of interest in a case where a sum of values of colored pixels around the pixel of interest in a predetermined region including the pixel of interest in image data including white pixels and the colored pixels is equal to or less than a threshold value, in which the threshold value is different for each pixel of the image data.

### CROSS-REFERENCE TO RELATED APPLICATIONS

This application is based on and claims priority under 35 USC 119 from Japanese Patent Application No. 2023-146656 filed Sep. 11, 2023.

### BACKGROUND

### (i) Technical Field

The present invention relates to an information processing system, a non-transitory computer readable medium storing a program, and an information processing method.

### (ii) Related Art

JP2019-149786A discloses a method that obtains an output image having high granularity in a case of converting a binary image into an image having a higher resolution. In this method, a ratio of colored dots to white dots assigned to colored pixels of interest (hereinafter, referred to as pixels of interest) is changed according to the percentage of the colored pixels in a predetermined region including the pixels of interest.

In the method disclosed in JP2019-149786A, as viewed from a second region having a larger size than the predetermined region (referred to as a first region), even though the number of colored pixels in the second region is almost identical, whether or not the pixel of interest is corrected may be switched depending on a difference in the number of colored pixels in the first region. This causes uneven density.

As a response to this, in a method disclosed in JP2021-114662A, in a case where the number of colored pixels in a first region having a pixel of interest as the center is equal to or less than a predetermined value, the number of colored pixels in a second region larger than the first region is examined. In a case where the number is equal to or less than the threshold value, the pixel of interest is corrected. In a case where the number is larger than the threshold value, the pixel of interest is not corrected. The correction performed here is called isolated point correction and is correction for reducing the density of the pixel of interest. That is, in this method, in a case where the number of colored pixels in the first region is equal to or less than the predetermined value and the number of colored pixels in the second region is equal to or less than the threshold value, the pixel of interest is determined to be an isolated point, and the density of the isolated point is reduced.

Further, in order to apply the methods disclosed in JP2019-149786A and JP2021-114662A, a multi-valued image is binarized by a method, such as a dither method or an error diffusion method, as preprocessing.

### SUMMARY

In the method that determines whether or not to correct the colored pixel of interest according to whether or not the number of colored pixels in the region including the pixel of interest (that is, the colored pixel of interest) in the binary image is equal to or less than a predetermined value, whether or not the pixel of interest is corrected is switched before and after a certain pixel value in the multi-valued image before binarization. Therefore, the density of a corrected image greatly changes between a case where the pixel value of the multi-valued image is the pixel value at the boundary and a case where the pixel value of the multi-valued image is one larger than the pixel value at the boundary. This problem will be described with reference to FIGS. 11, 12, and 13.

Here, a case where a multi-valued image is binarized by an ordered dither method will be described as an example. In the dither method, each pixel of the multi-valued image is binarized according to a magnitude relationship with a threshold value. The ordered dither method is a kind of dither method and binarizes the multi-valued image by dividing the multi-valued image into small blocks and comparing each block with a threshold value matrix having a size identical to the size of the block. FIG. 11 illustrates an example of the threshold value matrix which is composed of 8 x 8 threshold values.

Here, it is considered that the isolated point correction is performed on the binary image obtained by the binarization. For example, the following is assumed: in a case where the number of colored pixels in a region around the pixel of interest in the binary image is equal to or less than a threshold value, it is determined that the pixel of interest is the isolated point; and the isolated point correction is performed. In addition, hereinafter, it is assumed that the threshold value used for the binarization using the dither method is referred to as a dither threshold value and the threshold value used for determining the isolated point correction is referred to as a correction threshold value.

FIGS. 12 and 13 illustrate a situation in which two threshold value matrices illustrated in FIG. 11 are repeatedly applied vertically and horizontally to an image portion 100 of 16×16 pixels in a multi-valued image that is a source of a binary image. Of these drawings, FIG. 12 illustrates a case where all of the pixels in the image portion 100 of the multi-valued image have a pixel value of 7, and FIG. 13 illustrates a case where all of the pixels in the image portion 100 have a pixel value of 8. Further, here, the following is assumed: in a case where the value of the pixel (that is, the pixel value) is equal to or greater than the dither threshold value, the pixel is binarized into 1 of the binary values, that is, a colored pixel; and, in a case where the pixel value is less than the dither threshold value, the pixel is binarized into 0 of the binary values, that is, a white pixel.

In FIG. 12, pixels (for example, pixels 102 and 104) having a gray background color are pixels that are binarized into colored pixels, and a pixel (for example, a pixel 106) having a white background color other than the pixels is a pixel that is binarized into a white pixel. For example, the dither threshold value corresponding to the pixel 102 is 6 as illustrated in FIG. 12, and the pixel values of all of the pixels are 7 in FIG. 12. Therefore, since the pixel value of 7 of the pixel 102 is larger than the dither threshold value of 6, the pixel 102 is binarized into a colored pixel.

Here, a region 110 of 5×5 pixels surrounded by a thick broken line in FIG. 12 is a region used for determining the isolated point. The following is assumed: in a case where the number of colored pixels in the region 110 is equal to or less than the correction threshold value, it is determined that the pixel of interest is the isolated point; and the isolated point correction is performed on the pixel of interest. Here, it is assumed that the correction threshold value is 3. In a case where a colored pixel 108 is the pixel of interest, the region 110 is a region used for determination for the pixel of interest. Three colored pixels (this is the number of colored pixels excluding the pixel of interest) are present in the region 110 and 3, which is the number of colored pixels, is equal to or less than the correction threshold value of 3. Therefore, the colored pixel 108 which is the pixel of interest is determined to be the isolated point, and the isolated point correction for reducing the density is performed. In FIG. 12, among the colored pixels having the gray background color, the color pixel (for example, the colored pixel 108) to be subjected to the isolated point correction is surrounded by a thick frame. In the example illustrated in FIG. 12, the density of 16 colored pixels among 30 colored pixels in the image portion 100 is reduced by the isolated point correction.

On the other hand, in FIG. 13, since the pixel values of all of the pixels in the image portion 100 are 8, 32 pixels are binarized into colored pixels in the image portion 100. In a case where the colored pixel 108 is set as the pixel of interest among these pixels, the number of colored pixels in the region 110 of 5×5 pixels around the colored pixel 108 is 4. Since 4, which is the number of colored pixels, is larger than the correction threshold value of 3, the pixel of interest is not an object to be subjected to the isolated point correction. In the example illustrated in FIG. 13, each colored pixel in the image portion 100 has four or more colored pixels therearound in the region of 5×5 pixels. Therefore, there are no colored pixels to be subjected to the isolated point correction in the image portion 100.

As described above, in the example illustrated in FIG. 12 in which the pixel value is 7, there are 16 colored pixels whose density is reduced by the isolated point correction. However, in the example illustrated in FIG. 13 in which the pixel value is one larger than the pixel value in the example illustrated in FIG. 12, there are no colored pixels whose density is reduced by the isolated point correction.

As described above, as can be seen from the comparison between FIGS. 12 and 13, the density difference of the output image after correction is considerably large between a case where the pixel value of the multi-valued image which is the source of the binary image is 7 and a case where the pixel value is 8. In contrast, this large difference does not occur between other pixel values, for example, between pixel values of 9 and 10.

The case where the ordered dither method is used has been described above as an example. However, the identical problem also occurs in a case where other binarization methods, such as other dither methods or other error diffusion methods, are used.

Aspects of non-limiting embodiments of the present disclosure relate to an information processing system, a non-transitory computer readable medium storing a program, and an information processing method that prevent a large change in density of a corrected image of a binary image before and after a certain pixel value in a multi-valued image which is a source of the binary image.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to correct a pixel of interest that is a colored pixel of interest in a case where a sum of values of colored pixels around the pixel of interest in a predetermined region including the pixel of interest in image data including white pixels and the colored pixels is equal to or less than a threshold value. The threshold value is different for each pixel of the image data.

### BRIEF DESCRIPTION OF THE DRAWINGS

Exemplary embodiment(s) of the present invention will be described in detail based on the following figures, wherein:

FIG. 1 is a diagram illustrating an overall functional configuration of an image processing apparatus;

FIG. 2 is a diagram illustrating a functional configuration of a resolution conversion unit;

FIG. 3 is a diagram illustrating a processing procedure of the resolution conversion unit;

FIG. 4 is a diagram illustrating a distribution of correction threshold values that are different values for each pixel by application of a random number;

FIG. 5 is a diagram illustrating pixels to be subjected to isolated point correction in a case where the distribution of the correction threshold values illustrated in FIG. 4 is applied to a binarization result of a multi-valued input image having a pixel value of 7;

FIG. 6 is a diagram illustrating pixels to be subjected to the isolated point correction in a case where the distribution of the correction threshold values illustrated in FIG. 4 is applied to a binarization result of a multi-valued input image having a pixel value of 8;

FIG. 7 is a diagram illustrating an example of a weight distribution;

FIG. 8 is a diagram illustrating a functional configuration of a resolution conversion unit according to a modification example;

FIG. 9 is a diagram illustrating a processing procedure of the resolution conversion unit according to the modification example;

FIG. 10 is a diagram illustrating a hardware configuration of a computer in which an information processing system is implemented;

FIG. 11 is a diagram illustrating an example of a threshold value matrix used in an ordered dither method;

FIG. 12 is a diagram illustrating that the isolated point correction is performed on a large number of pixels in a case where a uniform correction threshold value of 3 is used for a result of binarizing a multi-valued input image having a pixel value of 7 using the threshold value matrix illustrated in FIG. 11; and

FIG. 13 is a diagram illustrating that there are no pixels to be subjected to the isolated point correction in a case where the uniform correction threshold value of 3 is used for a result of binarizing a multi-valued input image having a pixel value of 8 using the threshold value matrix illustrated in FIG. 11.

### DETAILED DESCRIPTION

Hereinafter, exemplary embodiments of the present invention will be described with reference to the drawings.

### Overall Configuration of Apparatus

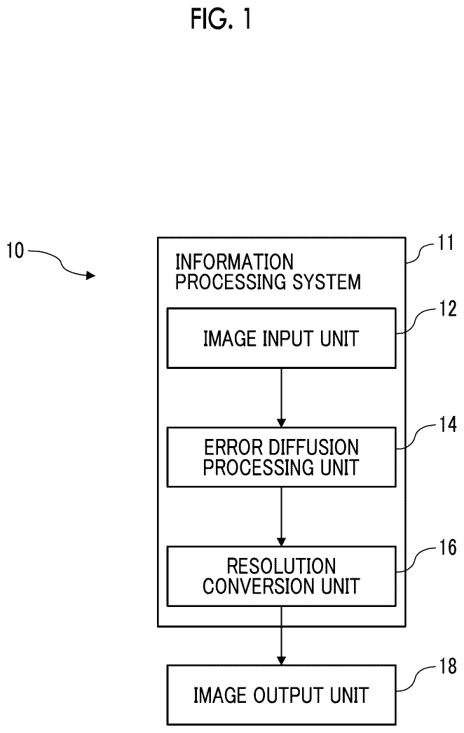

FIG. 1 illustrates an overall functional configuration of an image processing apparatus 10. The image processing apparatus 10 is, for example, an apparatus having a printing function such as a printer, a copying machine, or a multifunction machine (that is, a multifunction apparatus having functions of a printer, a scanner, a copying machine, a facsimile, and the like). The image processing apparatus 10 includes an information processing system 11 and an image output unit 18. The information processing system 11 is a functional module that performs information processing, such as image processing, on input image data. The image output unit 18 is a printing device, prints the input image data on a recording medium (hereinafter, referred to as a “sheet”), such as paper, and outputs the sheet. A printing method of the image output unit 18 is not particularly limited and may be, for example, an electrophotographic method or an inkjet method.

The information processing system 11 includes an image input unit 12, an error diffusion processing unit 14, and a resolution conversion unit 16.

The image input unit 12 receives an input of target image data. The image input unit 12 is, for example, a scanner that optically reads a document and converts the document into electronic image data. Further, the image input unit 12 may receive a file of image data that has been generated by an external device, such as a personal computer, and transmitted via a network or the like. In a case where the file of the image data is received, the image input unit 12 converts the image data included in the file into a bitmap image.

Further, in a case where a color space of the image data input to the image input unit 12 is different from a color space of the image output unit 18, the image input unit 12 performs color conversion to match the color space of the input image data with the color space of the image output unit 18. For example, in a case where the format of the input image data is an RGB format and the image output unit 18 handles a CMYK format, the image input unit 12 performs conversion from RGB into CMYK.

Therefore, the image data transmitted from the image input unit 12 to the error diffusion processing unit 14 is multi-valued (for example, each color is 8 bits) bitmap image data represented in the color space of the image output unit 18.

The error diffusion processing unit 14 performs a known error diffusion process on the multi-valued image data input from the image input unit 12 to convert the multi-valued image data into binary image data. For example, in a case where the input image data is multi-valued CMYK image data, the error diffusion processing unit 14 converts the multi-valued image of each of C, M, Y, and K into binary image data. The binary image data of each color is an image that is represented by white pixels having a density of 0 and colored pixels having a predetermined density.

The resolution conversion unit 16 converts the binary image data of each color output from the error diffusion processing unit 14 into image data having the resolution of the image output unit 18. The resolution of the binary image data of each color output from the error diffusion processing unit 14 is equal to the resolution of the image data input to the image input unit 12. On the other hand, the resolution of the image output unit 18 that performs printing may be higher than the resolution of the input image data. Therefore, the resolution conversion unit 16 converts the resolution of the binary image data subjected to the error diffusion.

Hereinafter, the resolution of the image data input to the resolution conversion unit 16, that is, the binary image data output by the error diffusion processing unit 14, is referred to as an input resolution, and the resolution of the image data output from the resolution conversion unit 16 is referred to as an output resolution. The input resolution is equal to the resolution of the image data input to the image input unit 12. The output resolution is equal to the resolution of the image output unit 18. In addition, hereinafter, the image data input to the resolution conversion unit 16 is referred to as input image data, and the image data output from the resolution conversion unit 16 is referred to as output image data. Further, pixels of the input image data are referred to as input pixels, and pixels of the output image data are referred to as output pixels.

In addition, the resolution conversion unit 16 also performs isolated point correction during resolution conversion. The isolated point correction is correction for reducing the density of the colored pixel which is only one isolated pixel. That is, in a case where the resolution conversion unit 16 finds a colored pixel corresponding to an isolated point from the input image data, the resolution conversion unit 16 performs the correction for reducing the density of the colored pixel.

The isolated point correction in the resolution conversion unit 16 is performed, for example, as follows.

It is considered that the resolution conversion unit 16 converts one input pixel into output pixels arranged in an m×n matrix (m and n are integers equal to or greater than 1). The area of the output pixel is 1/(m×n) of the area of the input pixel. In a case where at least one of m or n is equal to or greater than 2, the resolution of the output image data is higher than the resolution of the input image data. For example, in a case where resolution conversion is performed to convert one input pixel into a group of 2 rows and 4 columns of output pixels, the number of pixels of the output image data is 8 times the number of pixels of the input image data.

For the input pixel other than the isolated point, the resolution conversion unit 16 converts the input pixel into a group of m rows and n columns of output pixels having a value identical to the value of the input pixel. For example, in a case where the input pixel which is not the isolated point is a white pixel, the resolution conversion unit 16 converts the input pixel into a group of m×n white output pixels. Further, in a case where the input pixel that is not the isolated point is a colored pixel, the resolution conversion unit 16 converts the input pixel into a group of m×n colored output pixels. The density of each colored output pixel is equal to the density of the colored pixel which is the input pixel. Therefore, for the input pixel which is not the isolated point, the density thereof is not changed by the resolution conversion.

On the other hand, in a case where it is determined that the input pixel is the isolated point (that is, an isolated colored pixel), the resolution conversion unit 16 changes one or more output pixels in a group of m×n output pixels to white pixels to reduce the density. That is, the colored pixel which is not the isolated point is converted into a group of m×n colored output pixels. In the case of the colored pixel which is the isolated point, one or more colored output pixels in the group of m×n colored output pixels are replaced with white pixels. Therefore, the density is reduced. Further, in the isolated point correction, which pixel in the group of m×n output pixels is replaced with the white pixel may be determined according to a predetermined rule. In addition, a method for determining the isolated point in the present exemplary embodiment will be described in detail below.

The output image data output from the resolution conversion unit 16 is supplied to the image output unit 18. The image output unit 18 outputs an image on a sheet according to the output image data.

### Example of Resolution Conversion Unit

The isolated point correction according to the related art is performed on the basis of whether or not the number of colored pixels in a region with a predetermined size around a pixel of interest is equal to or less than a predetermined correction threshold value, and the correction threshold value used in this case is the identical value for all pixels.

In contrast, in the present exemplary embodiment, the correction threshold value is different for each pixel. For example, in the following description, a uniform correction threshold value applied to all pixels in the method according to the related art is set as a reference value, and the reference value is changed with a random number for each pixel to generate the correction threshold value for each pixel.

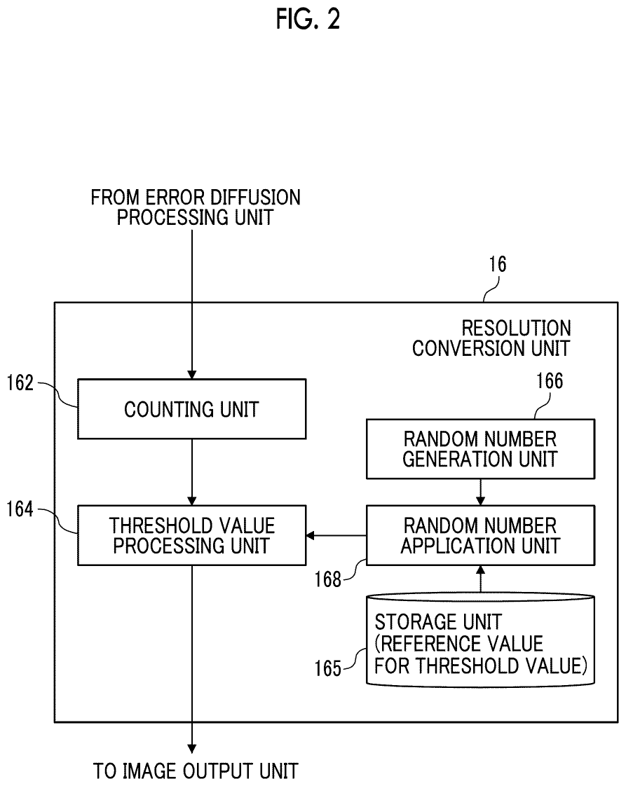

FIG. 2 illustrates an example of a configuration of the resolution conversion unit 16 having this threshold value change function.

The resolution conversion unit 16 illustrated in FIG. 2 includes a counting unit 162, a threshold value processing unit 164, a storage unit 165, a random number generation unit 166, and a random number application unit 168.

For each pixel of interest in the binary image data input from the error diffusion processing unit 14, the counting unit 162 counts the number of colored pixels in a region with a predetermined size around the pixel of interest.

The threshold value processing unit 164 compares the total number of colored pixels in the region calculated by the counting unit 162 with the correction threshold value to determine whether or not to perform the isolated point correction on the pixel of interest and generates an output corresponding to the pixel of interest according to the determination. In a case where the output is generated, the threshold value processing unit 164 converts one pixel of interest into a matrix of a plurality of output pixels. The input image data is converted into output image data having a higher resolution by this operation.

In this conversion, for the pixel of interest that is not to be subjected to the isolated point correction, the threshold value processing unit 164 outputs a group of m×n output pixels having a value identical to the value (that is, 0 or 1) of the pixel of interest. That is, the threshold value processing unit 164 outputs a group of m×n white output pixels in a case where the pixel of interest is a white pixel and outputs a group of m×n colored output pixels in a case where the pixel of interest is a colored pixel. In addition, for the pixel of interest that is to be subjected to the isolated point correction, the threshold value processing unit 164 changes some output pixels in the output pixel group to white pixels according to a predetermined rule and outputs the while pixels.

The threshold value processing unit 164 uses the threshold value for each pixel supplied from the random number application unit 168 as the threshold value used for the threshold value comparison.

The storage unit 165 stores the reference value for the correction threshold value. This reference value is a predetermined fixed value.

The random number generation unit 166 generates a random number for each pixel. The random number application unit 168 applies the random number generated for each pixel by the random number generation unit 166 to the reference value acquired from the storage unit 165 to generate the correction threshold value for each pixel. Therefore, a different correction threshold value can be obtained for each pixel.

A method for applying the random number to the reference value in the random number application unit 168 may be, for example, the addition of the random number to the reference value. In this case, for example, assuming that the reference value is 3 and the random number generation unit 166 randomly generates three values of −1, 0, and 1 for each pixel, the random number application unit 168 randomly outputs 2, 3, or 4 for each pixel. In this specific example, in a case where the correction threshold value for each pixel which is randomly output by the random number application unit 168 is averaged for a sufficiently large number of pixels (for example, all of the pixels of the input image data), the average value is substantially equal to the reference value. In a case where the average of the correction threshold values is equal to the reference value, the number of pixels subjected to the isolated point correction in the entire image can be close to the number of pixels in a case where the isolated point correction is performed on all of the pixels using the reference value as the correction threshold value.

Further, as another example, the random number application unit 168 may multiply the reference value by the random number generated by the random number generation unit 166. For example, the random number generation unit 166 randomly outputs five real numbers of 0.5, 0.8, 1, 1.2, and 1.5 for each pixel. Then, the random number application unit 168 multiplies the reference value (for example, 4) by the output value of the random number generation unit 166 and rounds off the value of the multiplication result to an integer to calculate the correction threshold value for each pixel. Even in this specific example, in a case where the correction threshold value for each pixel output by the random number application unit 168 is averaged for a sufficiently large number of pixels, the average value is substantially equal to the reference value.

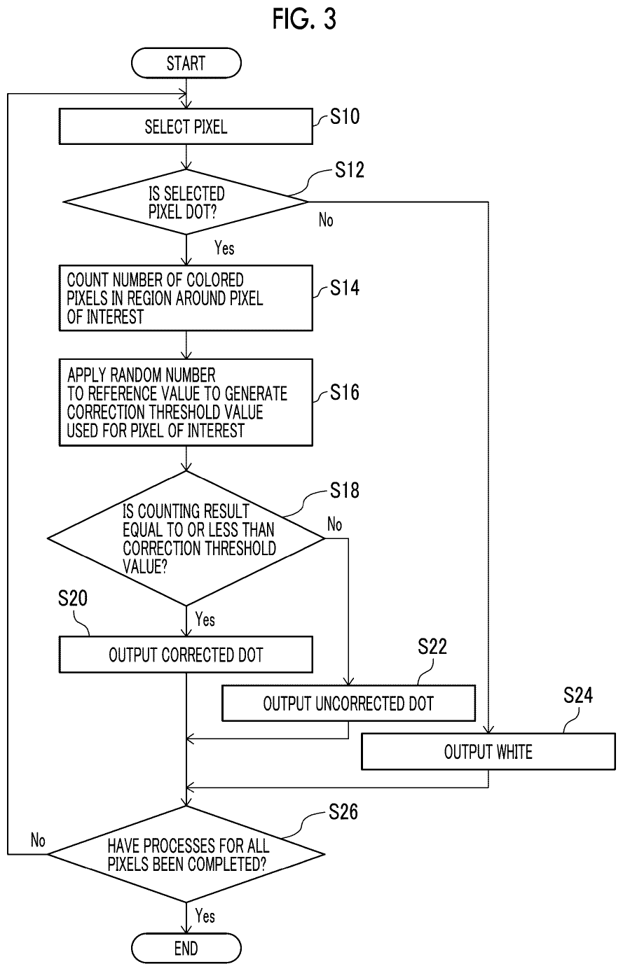

FIG. 3 illustrates an example of a processing procedure executed by the resolution conversion unit 16.

In the procedure illustrated in FIG. 3, the counting unit 162 selects one pixel from the input image data in a predetermined order (S10). Then, the counting unit 162 determines whether or not the selected pixel is a dot (that is, a colored pixel) (S12). In a case where the selected pixel is not a dot, that is, in a case where the selected pixel is a white pixel, the threshold value processing unit 164 outputs a group of m×n white pixels as an output pixel group corresponding to the pixel (S24).

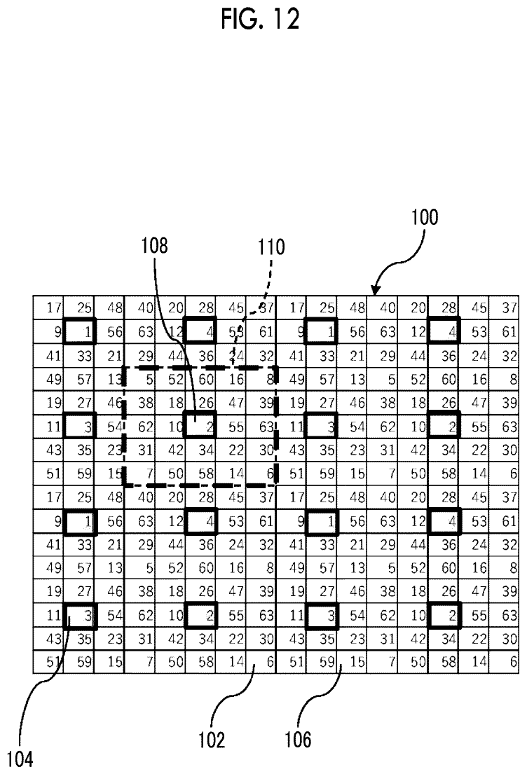

In a case where it is determined in S12 that the pixel is a dot, the counting unit 162 counts the number of colored pixels in a region with a predetermined size around the pixel (this is a colored pixel and is the pixel of interest in the following procedure) and calculates the total number of colored pixels in the region (however, the pixel of interest is excluded) (S14). This region may be, for example, a range of k×k pixels (k is an odd number equal to or greater than 3) having the pixel of interest as the center like the region 110 illustrated in FIG. 12.

Further, in this case, the threshold value processing unit 164 requests the random number generation unit 166 to generate a random number for the pixel of interest. The random number application unit 168 applies the random number generated by the random number generation unit 166 in response to the request to the reference value stored in the storage unit 165 to generate a correction threshold value for the pixel of interest (S16).

Then, the threshold value processing unit 164 determines whether or not the received counting result, that is, the total number of colored pixels in the region around the pixel of interest is equal to or less than the correction threshold value for the pixel of interest generated by the random number application unit 168 (S18). In a case where the counting result is equal to or less than the correction threshold value (the determination result in S18 is Yes), the threshold value processing unit 164 outputs a dot group subjected to the isolated point correction as an output pixel group corresponding to the pixel of interest (S20). That is, in this case, the threshold value processing unit 164 determines that the pixel of interest is the isolated point and performs the isolated point correction. In a case where S20 is performed, the pixel of interest is a dot (that is, a colored pixel). Therefore, in a case where the isolated point correction is not performed, the threshold value processing unit 164 outputs a dot group of m×n pixels as the result of the resolution conversion. However, since the isolated point correction is performed in S20, the threshold value processing unit 164 converts one or more dots determined by an isolated point correction rule in the dot group of m×n pixels into white pixels and outputs the white pixels. Therefore, the density of the output pixel group corresponding to the pixel of interest is lower than the density in a case where the isolated point correction is not performed.

In S20, the intensity of the isolated point correction may be changed depending on the counting result. That is, as the value of the final counting result is smaller, the density around the pixel of interest is lower. Therefore, the number of pixels to be converted into white pixels in the output pixel group may increase such that the density of the pixel of interest is reduced by the isolated point correction.

In a case where the determination result in S18 is No, that is, the counting result is equal to or greater than the correction threshold value, the threshold value processing unit 164 outputs the dot group of m×n pixels corresponding to the pixel of interest as the result of the resolution conversion without any change (S22). That is, in this case, the isolated point correction is not performed on the pixel of interest.

After S20, S22, or S24, the resolution conversion unit 16 determines whether or not the processes in S10 to S26 have been completed for all of the pixels of the input image data (S26). In a case where the determination result is No, the resolution conversion unit 16 returns to S10, selects the next pixel of interest from the input image data, and performs the processes after S12 on the pixel of interest.

In a case where the determination result in S26 is Yes, the resolution conversion unit 16 completes the resolution conversion process on the input image data.

As described above, in the present exemplary embodiment, the correction threshold value used for determining whether or not to perform the isolated point correction on the colored pixel is set to be different for each pixel by the random number. Therefore, the problem that the density of the correction result differs markedly before and after a certain pixel value in the stage of the multi-valued image is alleviated.

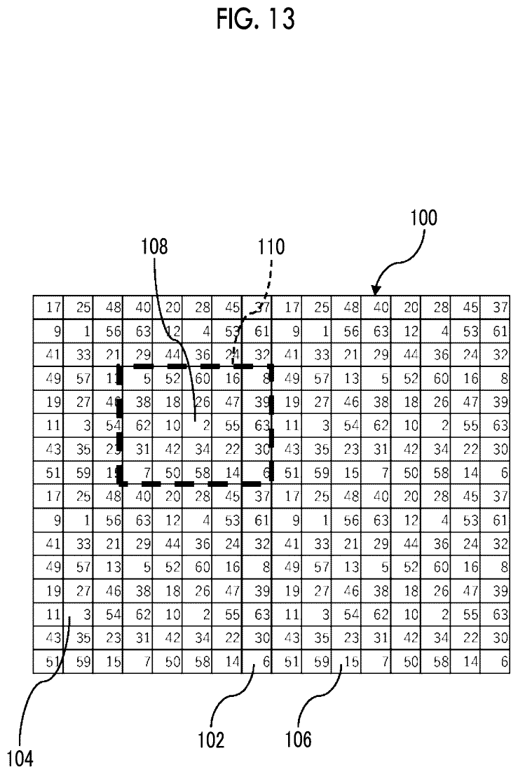

As a specific example, a case where the correction threshold value is set to be different for each pixel by the method according to the present exemplary embodiment in the example described above with reference to FIGS. 11 to 13 will be described below. In the following example, it is assumed that the reference value for the correction threshold value is 3 that is identical to the correction threshold value in the examples illustrated in FIGS. 12 and 13. In addition, it is assumed that the random number generation unit 166 randomly generates three values of −1, 0, and 1 for each pixel and the random number application unit 168 adds the randomly generated value to the reference value of 3.

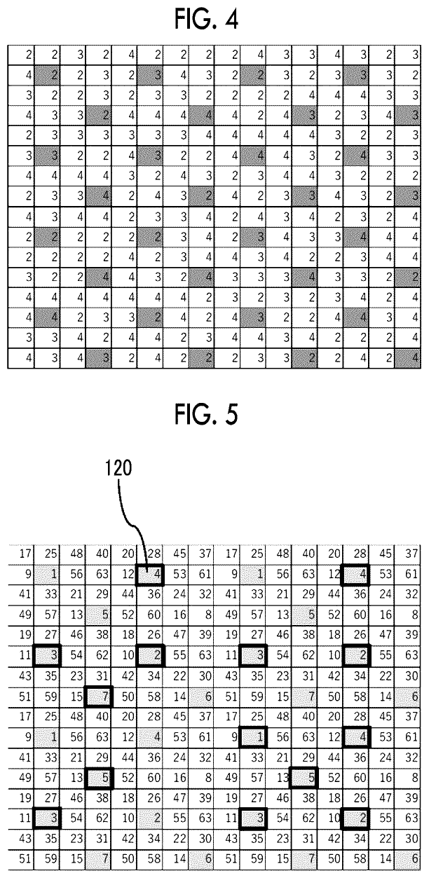

In this case, the correction threshold values for each pixel have a distribution illustrated in FIG. 4. In FIG. 4, a pixel in which a background color is gray is a pixel that has a gray background color in the examples illustrated in FIGS. 12 and 13 and that is classified into the colored pixel by binarization. As illustrated in FIG. 4, the correction threshold value is different for each colored pixel.

FIG. 5 illustrates the results of binarizing an image portion in which the pixel value of all of 16×16 pixels is 7 (this is a case identical to the case illustrated in FIG. 12) with the threshold value matrix illustrated in FIG. 11 and determining whether or not the isolated point correction needs to be performed on each colored pixel of the binarization result using the correction threshold value for the pixel illustrated in FIG. 4. In the example illustrated in FIG. 5, a pixel group surrounded by a thick frame, such as a pixel 120, is a pixel to be subjected to the isolated point correction and the total number of pixels is 14.

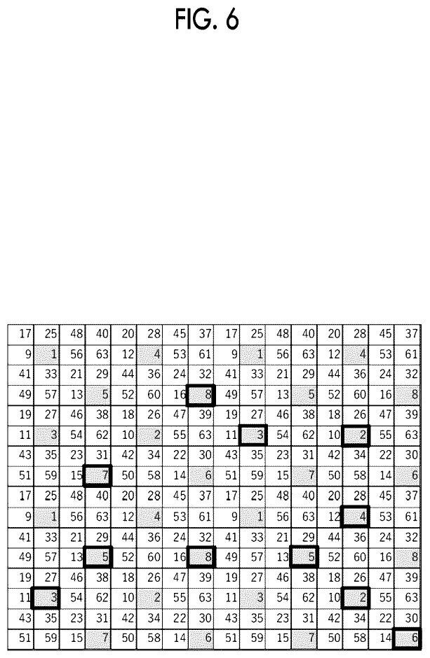

On the other hand, FIG. 6 illustrates the results of performing binarization and the determination of whether or not the isolated point correction needs to be performed which are identical to the binarization and determination in the example illustrated in FIG. 5 on an image portion in which the pixel value of all of 16×16 pixels is 8 (this is a case identical to the case illustrated in FIG. 13). In the example illustrated in FIG. 6, the total number of pixels that are surrounded by thick frames and are to be subjected to the isolated point correction is 11.

In the examples illustrated in FIGS. 12 and 13 in which a uniform correction threshold value of 3 is used for all of the pixels, in a case where the pixel value changes from 7 to 8, the number of pixels to be subjected to the isolated point correction suddenly changes from 16 to 0. In contrast, in the examples illustrated in FIGS. 5 and 6 in which the method according to the present exemplary embodiment is used, the number of pixels to be subjected to the isolated point correction only changes from 14 to 11 under the identical conditions, and the amount of change is much smaller. As described above, it can be seen that the problem that the density of the result of the isolated point correction greatly changes between the pixel values of 7 and 8 is resolved by the present exemplary embodiment.

As described above, in the present exemplary embodiment, since the correction threshold value is set to be different for each pixel, the situation in which the density after the isolated point correction changes greatly before and after a certain pixel value in the stage of the multi-valued image before binarization, which occurs in a case where a uniform correction threshold value is used for all of the pixels, is alleviated.

Further, in the present exemplary embodiment, since the correction threshold value is changed for each pixel by the random number, there is no regularity in the arrangement of the correction threshold values. Therefore, an artifact is unlikely to appear in the image subjected to the isolated point correction output from the resolution conversion unit 16.

### Modification Examples

In the above-described exemplary embodiment, the isolated point correction is controlled on the basis of the number of colored pixels in the region around the pixel of interest. In this method, in a case where the number of colored pixels is identical, the result of determining whether or not to perform the isolated point correction is identical regardless of whether the colored pixels are clustered close to or far away from the pixel of interest.

However, in a case where the distance of the colored pixel to the pixel of interest is different, a dot formed by printing the colored pixel may or may not overlap a dot formed by printing the pixel of interest. In a case where the dots do not overlap each other, it is said that the pixel of interest is isolated. However, in a case where the dots overlap each other, it is difficult to say that the pixel of interest is isolated. Therefore, for example, it is considered that it is better to consider the distance of the colored pixel to the pixel of interest (in other words, the colored pixel is close to or far away from the pixel of interest) in the control of the isolated point correction. Hereinafter, a modification example considering the distance will be described.

In this modification example, for the colored pixels around the pixel of interest, a colored pixel closer to the pixel of interest is given a smaller weight, and it is determined whether or not the pixel of interest is the isolated point on the basis of the sum of the weights for the colored pixels around the pixel of interest. Here, the weight is a value that is equal to or greater than 0.

More specifically, in this modification example, in a case where the sum of the weights for the colored pixels around the pixel of interest is less than a predetermined threshold value, it is determined that the pixel of interest is the isolated point. The colored pixel farther away from the pixel of interest is given a smaller weight, in other words, the colored pixel closer to the pixel of interest is given a larger weight. Therefore, as the number of colored pixels close to the pixel of interest is larger, the sum of the weights is more likely to be large. As a result, it is less likely that the pixel of interest is determined to be the isolated point.

On the contrary, in a case where there are no colored pixels near the pixel of interest, it is likely that the pixel of interest is determined to be the isolated point. For example, even in a case where there are many colored pixels far away from the pixel of interest and there are no colored pixels near the pixel of interest, the dots of the surrounding colored pixels may not overlap the dot of the pixel of interest at all in the printing result. In this case, since the pixel of interest is likely to be conspicuous as the isolated point, for example, it is advisable to set the pixel of interest as an object to be subjected to the isolated point correction.

In this modification example, on the basis of this idea, the sum of the weights for the colored pixels around the pixel of interest is calculated. Then, the sum is compared with the threshold value to determine whether or not to perform the isolated point correction on the pixel of interest.

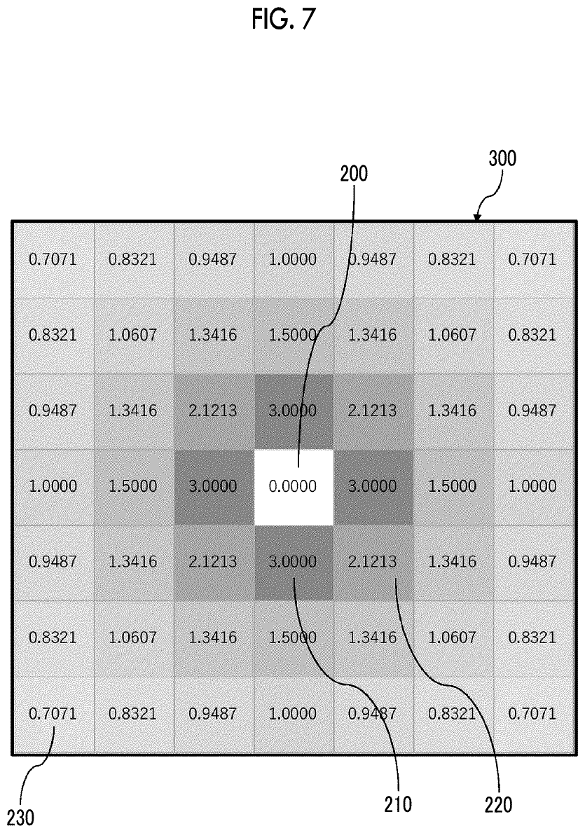

FIG. 7 illustrates an example in which weights are given to a pixel group around the pixel of interest. FIG. 7 illustrates a weight for each of pixel positions 210, 220, and the like in a region 300 of 7×7 pixels having a pixel of interest 200 as the center. In this example, a weight Wᵢⱼ for each pixel position (i, j) is calculated by the following expression.

### Expression 1

Wᵢⱼ=1/(i²+j²)^{½}×3

Here, i and j are an x-coordinate and a y-coordinate of each pixel position, respectively, in a case where the position of the pixel of interest 200 is set as the origin (0, 0). For example, the x-coordinate has a positive value on the right side and a negative value on the left side of the origin, and the y-coordinate has a positive value on the upper side and a negative value on the lower side of the origin. In this expression, the weight Wᵢⱼ is inversely proportional to the distance from the pixel of interest, and a proportionality constant is 3. In addition, the relationship that the weight is inversely proportional to the distance and the proportionality constant of 3 are just an example.

In the example illustrated in FIG. 7, since the pixel of interest 200 is not an object to be subjected to weight sum calculation, the weight for the position of the pixel of interest 200 is 0, the weight for the pixel position 210 of an adjacent pixel below the pixel of interest 200 is 3.0000, and the weight for the pixel position 220 of an adjacent pixel on the lower right side of the pixel of interest 200 is 2.1213. Further, the weight for a pixel position 230 of a pixel that is located at the lower left corner of the region 300 and is farthest from the pixel of interest 200 in the region 300 is 0.7071.

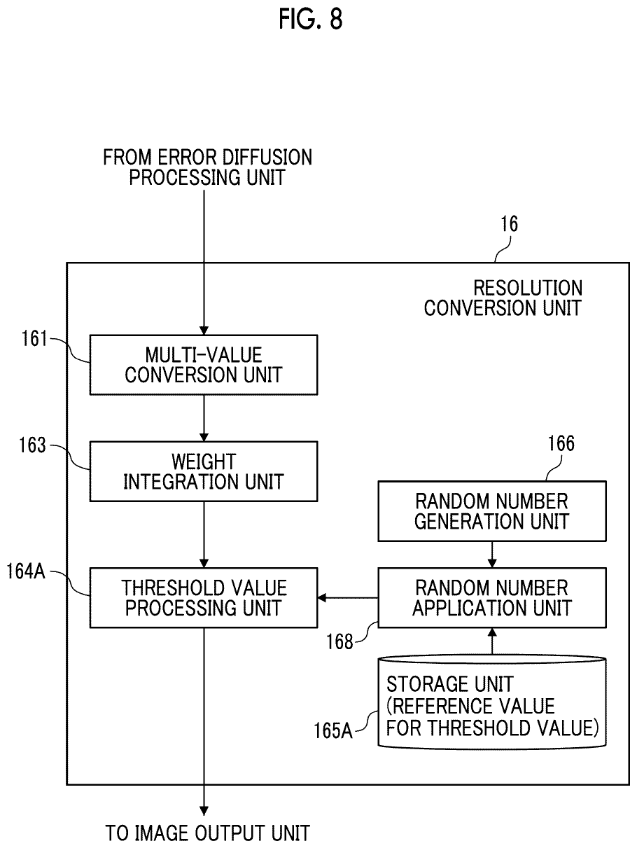

The overall configuration of the image processing apparatus 10 according to this modification example is similar to the overall configuration illustrated in FIG. 1 and is different from the overall configuration in the above-described exemplary embodiment illustrated in FIG. 2 in an internal configuration of the resolution conversion unit 16. FIG. 8 illustrates an example of the internal configuration of the resolution conversion unit 16 in this modification example. In FIG. 8, components identical to the components illustrated in FIG. 2 are denoted by the identical reference numerals, and a description thereof will not be repeated.

The resolution conversion unit 16 illustrated in FIG. 8 includes a multi-value conversion unit 161, a weight integration unit 163, a threshold value processing unit 164A, a storage unit 165A, the random number generation unit 166, and the random number application unit 168.

The multi-value conversion unit 161 converts the value of each pixel of binary image data input from the error diffusion processing unit 14 into multiple values. This conversion is for converting the value of the pixel into a real value identical to the weight such that the weight integration unit 163 can multiply the value by the weight. For example, in a case where a binary image is converted into 8-bit multiple values, the multi-value conversion unit 161 converts the value of a white pixel (that is, a value of 0) of the binary image into an 8-bit value indicating a real value of 0.0 and converts the value of a colored pixel (that is, a value of 1) of the binary image into an 8-bit value indicating a real value of 1.0. That is, the multi-value conversion unit 161 converts the binary image of 0 and 1 into a multi-bit image that is substantially a binary image of 0.0 and 1.0.

The weight integration unit 163 sets each pixel of the multi-valued image data output from the multi-value conversion unit 161 as the pixel of interest and calculates the sum of weights for the colored pixels around the pixel of interest for each pixel of interest.

The threshold value processing unit 164A compares the sum of the weights calculated by the weight integration unit 163 with a threshold value to determine whether or not to perform the isolated point correction on the pixel of interest and generates an output corresponding to the pixel of interest according to the determination. In the generation of the output, the threshold value processing unit 164A converts one pixel of interest into a matrix of a plurality of output pixels. The input image data is converted into output image data having a higher resolution by this operation.

In this conversion, for the pixel of interest that is not to be subjected to the isolated point correction, the threshold value processing unit 164A outputs an output pixel group of m×n pixels having a value identical to the value (that is, 0 or 1) of the pixel of interest. That is, the threshold value processing unit 164A outputs a group of m×n white output pixels in a case where the pixel of interest is a white pixel and outputs a group of m×n colored output pixels in a case where the pixel of interest is a colored pixel. In addition, for the pixel of interest that is to be subjected to the isolated point correction, the threshold value processing unit 164A converts some pixels in the output pixel group into white pixels according to a predetermined rule and outputs the white pixels.

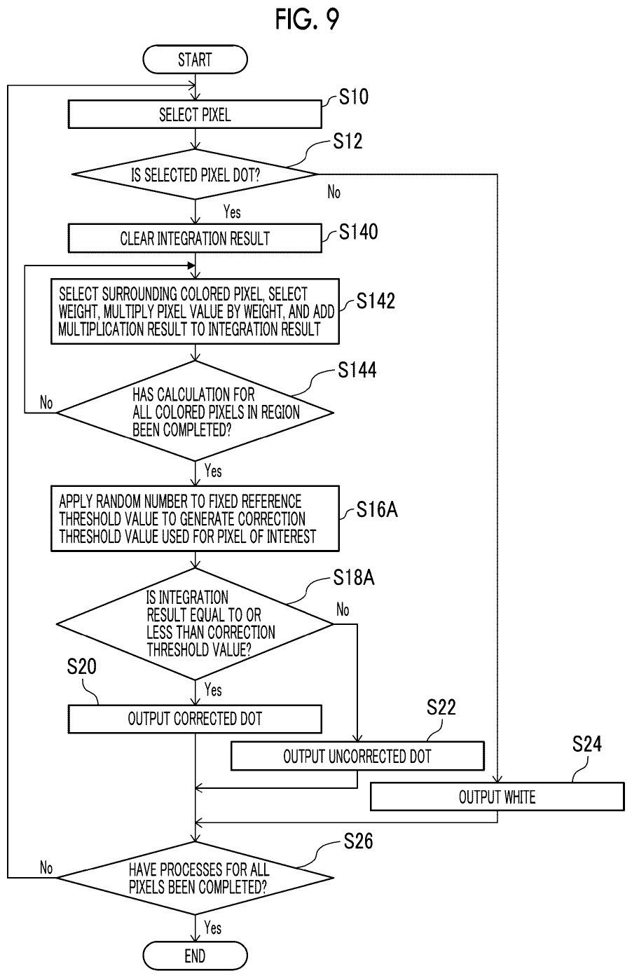

FIG. 9 illustrates a processing procedure executed by the weight integration unit 163 and the threshold value processing unit 164A. In FIG. 9, steps identical to the steps in the processing procedure according to the above-described exemplary embodiment illustrated in FIG. 3 are denoted by the identical reference numerals. Further, in this description, FIG. 8 is also referred to.

In the procedure illustrated in FIG. 9, the weight integration unit 163 selects one pixel from the input image data in a predetermined order (S10). Then, the weight integration unit 163 determines whether or not the selected pixel is a dot (that is, a colored pixel) (S12). In a case where the pixel selected by the weight integration unit 163 is not a dot, that is, in a case where the pixel is a white pixel, the threshold value processing unit 164A outputs a white pixel group of m×n pixels as the output pixel group corresponding to the pixel (S24).

In a case where it is determined in S12 that the selected pixel is a dot (that is, a colored pixel), the weight integration unit 163 clears the value of the integration result held as an internal variable to 0 (S140). Then, the weight integration unit 163 examines pixels in the region 300 (see FIG. 7) with a predetermined size around the pixel, that is, the pixel of interest 200, in a predetermined order. In a case where the weight integration unit 163 finds a colored pixel, the weight integration unit 163 calculates a weight for the position of the colored pixel from a weight distribution (for example, FIG. 7). Then, the weight integration unit 163 multiplies the value of the colored pixel by the weight and adds the obtained multiplication result to the integration result (S142). Then, the weight integration unit 163 determines whether or not all of the pixels in the region 300 have been examined (S144). In a case where there is an unexamined pixel, the weight integration unit 163 returns to S142 and processes the unexamined pixel.

In a case where the weight integration unit 163 determines in S144 that all of the pixels have been examined, the value of the sum of the results of multiplying the values of the colored pixels in the region 300 by the weights for the colored pixels is held in the integration result which is the internal variable. Since the value of the colored pixel is a real value of 1.0, the final integration result ultimately indicates the sum of the weights for the colored pixels in the region 300. The weight integration unit 163 transmits the final integration result to the threshold value processing unit 164A.

In a case where the threshold value processing unit 164A receives the final integration result for the pixel of interest from the weight integration unit 163, the threshold value processing unit 164A performs a process for obtaining the correction threshold value used for determining the pixel of interest (S16A). That is, the threshold value processing unit 164A requests the random number generation unit 166 to generate a random number for the pixel of interest. The random number application unit 168 applies the random number generated by the random number generation unit 166 in response to the request to the reference value stored in the storage unit 165A to generate the correction threshold value for the pixel of interest. The reference value stored in the storage unit 165A is the reference value for the correction threshold value for comparison with the weight integration result. This reference value is a value that is different from the reference value for the threshold value for comparison with the total number of colored pixels in the region which is stored in the storage unit 165 illustrated in FIG. 2.

Then, the threshold value processing unit 164A determines whether the received final integration result, that is, the sum of the weights for the colored pixels around the pixel of interest in the region is equal to or less than the correction threshold value for the pixel of interest generated by the random number application unit 168 (S18A).

In a case where the integration result is equal to or less than the correction threshold value (the determination result in S18A is Yes), the threshold value processing unit 164A outputs a dot group subjected to the isolated point correction as the output pixel group corresponding to the pixel of interest (S20). In a case where the determination result in S18A is No, that is, in a case where the integration result is greater than the correction threshold value, the threshold value processing unit 164A outputs a dot group of m×n pixels corresponding to the pixel of interest as the result of the resolution conversion without any change (S22).

After S20, S22, or S24, the resolution conversion unit 16 determines whether or not the processes in S10 to S26 have been completed for all of the pixels of the input image data (S26). In a case where the determination result is No, the resolution conversion unit 16 returns to S10, selects the next pixel of interest from the input image data, and performs the processes after S12 on the pixel of interest.

In a case where the determination result in S26 is Yes, the resolution conversion unit 16 completes the resolution conversion process on the input image data.

As described above, in this modification example, a smaller weight is given to the colored pixel that is further away from the pixel of interest. In a case where the sum of the weights for the colored pixel group around the pixel of interest is less than the threshold value, the isolated point correction is performed on the pixel of interest. This method makes it possible to make a finer determination as compared to the above-described exemplary embodiment in which it is determined whether or not the isolated point correction needs to be performed on the basis of the number of colored pixels.

The above-described exemplary embodiment is only an example, and various modifications can be made within the scope of the technical idea of the present invention. For example, the image processing apparatus 10 binarizes the input multi-valued image data using error diffusion. However, the binarization method is not limited thereto. Of course, the binarization may be performed by another method such as a dither method.

Further, in the example illustrated in FIG. 1, the image processing apparatus 10 includes the image output unit 18. However, a configuration may be adopted in which the image processing apparatus 10 does not include the image output unit 18. In this case, the image processing apparatus 10 may receive an image to be printed by an external printer from a host, perform binarization and resolution conversion (including isolated point correction) on the image using the method according to the present exemplary embodiment, and supply an image obtained as the result of the binarization and the resolution conversion to the printer.

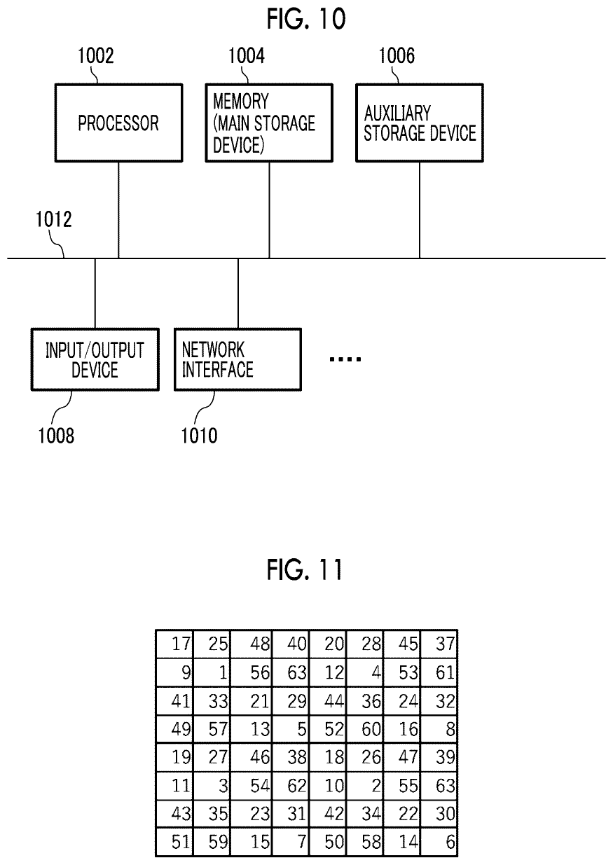

The information processing system 11 of the image processing apparatus 10 described above is configured using, for example, a general-purpose computer. For example, as illustrated in FIG. 10, the computer has a circuit configuration in which a processor 1002, a memory (main storage device) 1004, such as a random access memory (RAM), a controller that controls an auxiliary storage device 1006, which is a non-volatile storage device, such as a flash memory, a solid state drive (SSD), or a hard disk drive (HDD), an interface with various input and output devices 1008, a network interface 1010 that performs control for connection to a network, such as a local area network, and the like are connected via a data transmission path such as a bus 1012. A program in which the content of the processes according to the above-described exemplary embodiment has been described is installed in the computer via the network or the like and stored in the auxiliary storage device 1006. The processor 1002 executes the program stored in the auxiliary storage device 1006 using the memory 1004 to implement an information processing mechanism according to the present exemplary embodiment. Further, the information processing system 11 may include an image processing processor or the like that performs image processing for general purposes or a specific purpose at a high speed.

Furthermore, the information processing system 11 may be configured by a single computer or a plurality of computers. For example, some of the functions of the information processing system 11 may be provided in another computer outside the image processing apparatus 10.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1))

An information processing system comprising:
a processor configured to:
   correct a pixel of interest that is a colored pixel of interest in a case where a sum of values of colored pixels around the pixel of interest in a predetermined region including the pixel of interest in image data including white pixels and the colored pixels is equal to or less than a threshold value,
wherein the threshold value is different for each pixel of the image data.

(((2)))

The information processing system according to (((1))),
wherein the threshold value is determined for each of the pixels on the basis of a random number.

(((3)))

The information processing system according to (((2))),
wherein the threshold value is obtained by changing a predetermined reference value for each pixel of the image data using the random number.

(((4)))

The information processing system according to (((3))),
wherein an average of the threshold values for each pixel of the image data is equal to the reference value.

(((5)))

The information processing system according to any one of (((1))) to (((4))),
wherein the value of each of the colored pixels around the pixel of interest is 1, and the sum indicates a total number of the colored pixels around the pixel of interest in the region.

(((6)))

The information processing system according to any one of (((1))) to (((4))),
wherein the value of each of the colored pixels around the pixel of interest is a weight that is larger as the colored pixel is closer to the pixel of interest.

(((7)))

A program causing a computer to execute:
a process of correcting a pixel of interest that is a colored pixel of interest in a case where a sum of values of colored pixels around the pixel of interest in a predetermined region including the pixel of interest in image data including white pixels and the colored pixels is equal to or less than a threshold value,
wherein the threshold value is different for each pixel of the image data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
correct a pixel of interest that is a colored pixel of interest in a case where a sum of values of colored pixels around the pixel of interest in a predetermined region including the pixel of interest in image data including white pixels and the colored pixels is equal to or less than a threshold value,
wherein the threshold value is different for each pixel of the image data.

2. The information processing system according to claim 1,
wherein the threshold value is determined for each of the pixels on the basis of a random number.

3. The information processing system according to claim 2,
wherein the threshold value is obtained by changing a predetermined reference value for each pixel of the image data using the random number.

4. The information processing system according to claim 3,
wherein an average of the threshold values for each pixel of the image data is equal to the reference value.

5. The information processing system according to claim 1,
wherein the value of each of the colored pixels around the pixel of interest is 1, and the sum indicates a total number of the colored pixels around the pixel of interest in the region.

6. The information processing system according to claim 1,
wherein the value of each of the colored pixels around the pixel of interest is a weight that is larger as the colored pixel is closer to the pixel of interest.

7. A non-transitory computer readable medium storing a program causing a computer to execute:
a process of correcting a pixel of interest that is a colored pixel of interest in a case where a sum of values of colored pixels around the pixel of interest in a predetermined region including the pixel of interest in image data including white pixels and the colored pixels is equal to or less than a threshold value,
wherein the threshold value is different for each pixel of the image data.

8. An information processing method comprising:
correcting a pixel of interest that is a colored pixel of interest in a case where a sum of values of colored pixels around the pixel of interest in a predetermined region including the pixel of interest in image data including white pixels and the colored pixels is equal to or less than a threshold value,
wherein the threshold value is different for each pixel of the image data.
